(19) United States
(12) Patent Application Publication
(10) Pub. No.: US 2025/0124313 A1
(43) Pub. Date: Apr. 17, 2025

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Kosuke AKIMOTO, Tokyo (JP); Kunihiro TAKEOKA, Tokyo (JP); Masafumi OYAMADA, Tokyo (JP)

(73) Assignee: NEC Corporation, Minato-ku, Tokyo (JP)

(21) Appl. No.: 18/703,421

(22) PCT Filed: Nov. 11, 2021
(86) PCT No.: PCT/JP2021/041587

§ 371 Date: Apr. 22, 2024

(51) Int. Cl. G06N 5/048; G06F 40/279

(52) U.S. Cl. CPC G06N 5/048; G06F 40/279

(57) ABSTRACT

To determine, with high accuracy, a label to be given to an object even in a case where only a single prediction model exists, an information processing apparatus (1) includes: an acquisition unit (11) that acquires a set of objects; an evaluation unit (12) that evaluates a degree of similarity between objects included in the set of objects and identifies one or a plurality of similar objects which are similar to a prediction target object; and a prediction unit (13) that determines a label to be given to the prediction target object with reference to a similar label(s), the similar label(s) being a label(s) which is/are given to each of the one or a plurality of similar objects and which has/have been predicted by a prediction model.

### TECHNICAL FIELD

The present invention relates to an information processing apparatus, an information processing method, and an information processing program.

### BACKGROUND ART

In creating training data which is required for training of a machine learning model, a task called annotation in which correct answers are given manually is required. Manual annotation is known to be costly. In order to lower the cost of the annotation, there is a technique to assist the annotation by predicting a correct answer with use of a prediction model. In this technique, when a correct answer to be given to an annotation target is predicted by the prediction model, a prediction result is corrected in order to supplement the accuracy of the prediction model. For example, Non-patent Literature 1 describes that prediction is carried out with use of a plurality of prediction models with respect to a feature value of a prediction target, and the prediction result is modified by processing using a statistical model.

### CITATION LIST

### Non-Patent Literature

### [Non-patent Literature 1]

Ratner, Alexander, et al., “Snorkel: Rapid training data creation with weak supervision,” Proceedings of the VLDB Endowment, International Conference on Very Large Data Bases, Vol. 11, No. 3, NIH Public Access, 2017

### SUMMARY OF INVENTION

### Technical Problem

The technique described in Non-patent Literature 1 requires a plurality of prediction models. Therefore, in a case where only a single prediction model exists, there is a problem that a prediction result cannot be properly corrected.

An example aspect of the present invention has been made in view of the above problem, and an example of the object is to provide a technique capable of determining a label to be given to an object with high accuracy even in a case where only a single prediction model exists.

### Solution to Problem

An information processing apparatus in accordance with an example aspect of the present invention includes: an acquisition means for acquiring a set of objects; an evaluation means for evaluating a degree of similarity between objects included in the set of objects and identifying one or a plurality of similar objects which are similar to a prediction target object; and a prediction means for determining a label to be given to the prediction target object with reference to a similar label(s), the similar label(s) being a label(s) which is/are given to each of the one or a plurality of similar objects and which has/have been predicted by a prediction model.

An information processing method in accordance with an example aspect of the present invention includes: acquiring a set of objects; evaluating a degree of similarity between objects included in the set of objects and identifying one or a plurality of similar objects which are similar to a prediction target object; and determining a label to be given to the prediction target object with reference to a similar label(s), the similar label(s) being a label(s) which is/are given to each of the one or a plurality of similar objects and which has/have been predicted by a prediction model.

An information processing program in accordance with an example aspect of the present invention causes a computer to carry out: a process of acquiring a set of objects; a process of evaluating a degree of similarity between objects included in the set of objects and identifying one or a plurality of similar objects which are similar to a prediction target object; and a process of determining a label to be given to the prediction target object with reference to a similar label(s), the similar label(s) being a label(s) which is/are given to each of the one or a plurality of similar objects and which has/have been predicted by a prediction model.

### Advantageous Effects of Invention

According to an example aspect of the present invention, it is possible to determine a label to be given to an object with high accuracy even in a case where only a single prediction model exists.

### BRIEF DESCRIPTION OF DRAWINGS

FIG. 1 is a block diagram illustrating a configuration of an information processing apparatus in accordance with a first example embodiment.

FIG. 2 is a flowchart illustrating a flow of an information processing method in accordance with the first example embodiment.

FIG. 3 is a block diagram illustrating a configuration of an information processing apparatus in accordance with a second example embodiment.

FIG. 4 is a flowchart illustrating an example of a flow of an information processing method in accordance with the second example embodiment.

FIG. 5 is a view for describing a specific example of a process that is carried out by an evaluation unit and a prediction unit in accordance with the second example embodiment.

FIG. 6 is a flowchart illustrating an example of a flow of an information processing method in accordance with the second example embodiment.

FIG. 7 is a view schematically illustrating a process that is carried out by the evaluation unit and the prediction unit in accordance with the second example embodiment.

FIG. 8 is a view illustrating a specific example of the process that is carried out by the evaluation unit and the prediction unit in accordance with the second example embodiment.

FIG. 9 is a flowchart illustrating an example of a flow of an information processing method in accordance with the second example embodiment.

FIG. 10 is a flowchart illustrating an example of a flow of an information processing method in accordance with the second example embodiment.

FIG. 11 is a block diagram illustrating a configuration of an information processing apparatus in accordance with a third example embodiment.

FIG. 12 is a flowchart illustrating an example of a flow of an information processing method in accordance with the third example embodiment.

FIG. 13 is a view illustrating a specific example of a hierarchical relationship of classes and sorting carried out by a prediction unit in accordance with the third example embodiment.

FIG. 14 is a block diagram illustrating a configuration of an information processing apparatus in accordance with a fourth example embodiment.

FIG. 15 is a view illustrating an example of a screen in accordance with the fourth example embodiment.

FIG. 16 is a view illustrating an example of a screen in accordance with the fourth example embodiment.

FIG. 17 is a block diagram illustrating a configuration of a computer that functions as the information processing apparatuses in accordance with each of the example embodiments.

### DESCRIPTION OF EMBODIMENTS

### First Example Embodiment

A first example embodiment of the present invention will be described in detail with reference to the drawings. The present example embodiment is a basic form of an example embodiment described later.

### <Outline of Information Processing Apparatus>

An information processing apparatus 1 in accordance with the present example embodiment is an apparatus that determines a label to be given to an object. Here, the object is a target to which a label is given. As an example, the object is data representing an image or a text which are a target for classification. The object may be data representing a commodity which is a target for sales prediction. The object may be an entity included in a sentence written in a natural language or may be data representing a pair made up of a sentence written in a natural language and an entity included in the sentence. Here, the entity is a character string representing a specific concept or a specific object, and is, as an example, a proper noun or a general noun.

The label is a value given to an object or a set of values given to an object. The label has, as an example, a data structure that includes a numerical value, such as a scalar, a vector, or a matrix. Further, the label may have a data structure that includes a character string. The object may be given a plurality of labels. Further, the label may be given a score representing the reliability of the label. Giving a plurality of labels to the object can be expressed as “giving a combination of values of a plurality of labels as the labels to be given to the object”. As an example, the object to which the label is given is used as training data for training a machine learning model. Hereinafter, giving a label to an object is also referred to as “annotation”.

### <Configuration of Information Processing Apparatus 1>

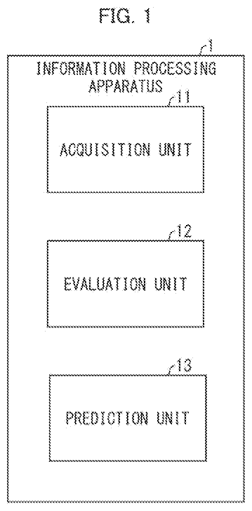

A configuration of an information processing apparatus 1 in accordance with the present example embodiment will be described with reference to FIG. 1. FIG. 1 is a block diagram illustrating the configuration of the information processing apparatus 1. As illustrated in FIG. 1, the information processing apparatus 1 includes an acquisition unit 11, an evaluation unit 12, and a prediction unit 13.

### (Acquisition Unit 11)

The acquisition unit 11 acquires a set of objects. The set of objects is, as an example, a set of pieces of image data, a set of pieces of text data, or a set of pieces of data representing a commodity. The set of objects may also be a set of pieces of data representing a pair made up of a sentence and an entity included in the sentence.

### (Evaluation Unit 12)

The evaluation unit 12 evaluates the degree of similarity between objects included in the object set and identifies one or a plurality of similar objects which are similar to a prediction target object. Here, the prediction target object is a target to which a label is given. In addition, in the present specification, the expression “objects are similar” includes the meaning that objects have features similar to each other, and the meaning that objects have features identical to each other. In other words, the expression “objects are similar” includes the meaning that “objects are identical to each other”.

The degree of similarity between objects represents the level of similarity between objects. As an example, the evaluation unit 12 evaluates the degree of similarity between objects on the basis of respective feature values of the objects. Here, the feature value is a set of values representing a feature of an object. The feature value may have, as an example, a data structure that includes a numerical value, such as a scalar, a vector, or a matrix, or may include a data structure that includes a character string. The feature value includes, as an example, a set of pixel values of an image, a set of words included in a text, or an attribute value such as a price of a commodity.

A method by which the evaluation unit 12 identifies a similar object is not limited, and examples of the method include (i) a method in which the evaluation unit 12 outputs a set of similar objects which are similar to a prediction target object and (ii) a method in which the evaluation unit 12 outputs a graph or a hypergraph representing a similarity relationship between objects. However, the method by which the evaluation unit 12 identifies a similar object is not limited to these examples, and the evaluation unit 12 may identify a similar object by other method.

In a case where (i) the evaluation unit 12 outputs a set of similar objects, the evaluation unit 12 identifies, as an example, an object such that the degree of similarity of the object to the prediction target object is equal to or greater than a predetermined threshold value. Further, the evaluation unit 12 may perform clustering on objects by using a clustering method, such as spectral clustering, using the degree of similarity between the objects to identify, as similar objects, objects belonging to the same cluster as the prediction target object. The similar objects may be given, as additional information, weight information commensurate with the degree of similarity.

Here, the similarity relationship in a set of similar objects does not need to be bidirectional. For example, in a case where the prediction target object is an object OBJ_A, and similar objects similar to the object OBJ_A are objects OBJ_B, OBJ_C, OBJ_D, and OBJ_E, the object OBJ_A does not have to be included in a set of similar objects similar to the object OBJ_B. Further, the object OBJ_A may be included in the set of similar objects similar to the object OBJ_A.

In a case where (ii) the evaluation unit 12 outputs a graph or a hypergraph representing a similarity relationship between objects, the evaluation unit 12 outputs, as an example, a graph or a hypergraph that regards the objects as nodes and that has an edge or a hyperedge connecting the nodes which have been evaluated in terms of the degree of similarity. These edges or hyper edges may be each given weight information commensurate with the degree of similarity between the corresponding nodes.

### (Prediction Unit 13)

The prediction unit 13 determines a label to be given to the prediction target object with reference to a similar label(s) that is/are a label(s) which is/are given to each of the one or a plurality of similar objects having been identified by the evaluation unit 12 and which has/have been predicted by a prediction model. The similar label(s) may be given to the similar object(s) in advance. Alternatively, the similar label(s) may be predicted by the prediction unit 13 with use of a prediction model. In addition, a plurality of similar labels may be given to one similar object.

The prediction model is a model that predicts a label of an object or a value included in the label. The prediction model may be a machine learning model generated by machine learning or may be a rule-based system or a system that refers to an external database. An input to the prediction model is, as an example, a feature value of an object. An output from the prediction model is, as an example, a label corresponding to the inputted feature value or a value included in the label. Here, the value included in the label is a value that constitutes the label in whole or in part, and the value included in the label is, for example, each element of a vector when the label is a vector. Further, the output from the prediction model may include a pair made up of values of a plurality of labels and respective scores of, for example, reliability of the labels. The prediction model may be stored in a memory of the information processing apparatus 1 or may be stored in another apparatus capable of communicating with the information processing apparatus 1.

A label predicted by the prediction model may be given on an as-is basis to a similar object as a similar label, and one or some of labels predicted by the prediction model may be given to a similar object as a similar label(s). As an example, K (K is a natural number of not less than 1) top-ranked labels, which are likely to be a similar label(s) of the prediction target model among a plurality of labels, may be given to a similar object as a similar label(s).

A method by which the prediction unit 13 determines a label to be given to the prediction target object with reference to a similar label(s) is not limited. As an example, the prediction unit 13 may predict a label of the prediction target object once with use of the prediction model and replace the predicted label by a label that is obtained with reference to a similar label(s) of a similar object(s). Alternatively, the prediction unit 13 may omit the prediction of a label of the prediction target object by the prediction model and give, to the prediction target object, the label that is obtained with reference to the similar label(s) of the similar object(s). Further, additional information such as a score may be attached to the label determined by the prediction unit 13.

More specifically, as an example, the prediction unit 13 may sum up scores attached to similar labels for each similar label and determine, as the label to be given to the prediction target object, a similar label that has the largest total score value.

Further, as an example, in a case where, as a result of the prediction of a label of the prediction target object by the prediction model, the label predicted by the prediction model is included in a set of similar labels, the prediction unit 13 may determine the predicted label on an as-is basis as the label to be given to the prediction target object. On the other hand, in a case where the label of the prediction target object predicted by the prediction model is not included in the set of similar labels, the prediction unit 13 may determine the label to be given to the prediction target object from the set of similar labels. In this case, as an example, the prediction unit 13 may determine, as the label to be given, a similar label that is most likely to be a similar label of the prediction target object among a set of similar labels. Here, the prediction unit 13 may evaluate the likelihood of a similar label with reference to additional information such as a score attached to a similar label or may evaluate the likelihood of a similar label with reference to the frequency (number) of similar labels in the set of similar labels.

Note that the method by which the prediction unit 13 determines the label to be given to the prediction target object is not limited to the above-described examples. The prediction unit 13 may determine the label to be given to the prediction target object by other method.

As described above, the information processing apparatus 1 in accordance with the present example embodiment employs the configuration in which a set of objects is acquired, the degree of similarity between objects included in the set of objects is evaluated, one or a plurality of similar objects which are similar to a prediction target object is/are identified, and a label to be given to the prediction target object is determined with reference to a similar label(s) that is/are a label(s) which is/are given to each of the one or a plurality of similar objects and which has/have been predicted by a prediction model. Therefore, according to the information processing apparatus 1 in accordance with the present example embodiment, it is possible to obtain an effect of making it possible to determine a label to be given to an object with high accuracy even in a case where only a single prediction model exists.

### <Flow of Information Processing Method>

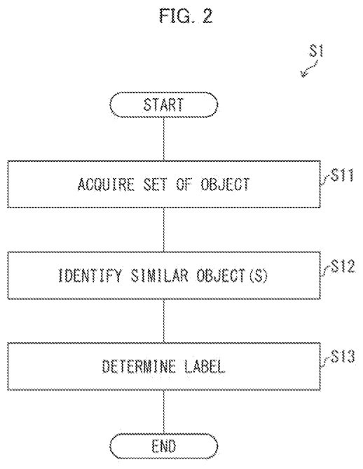

A flow of an information processing method S1 in accordance with the present example embodiment will be described with reference to FIG. 2. FIG. 2 is a flowchart illustrating a flow of the information processing method S1.

In step S11, the acquisition unit 11 acquires a set of objects. In step S12, the evaluation unit 12 evaluates the degree of similarity between objects included in the set of objects and identifies one or a plurality of similar objects which are similar to a prediction target object. In step S13, the prediction unit 13 determines a label to be given to the prediction target object with reference to a similar label(s) that is/are a label(s) which is/are given to each of the one or a plurality of similar objects and which has/have been predicted by a prediction model.

As described above, the information processing method S1 in accordance with the present example embodiment employs the configuration in which a set of objects is acquired, the degree of similarity between objects included in the set of objects is evaluated, one or a plurality of similar objects which are similar to a prediction target object is/are identified, and a label to be given to the prediction target object is determined with reference to a similar label(s) that is/are a label(s) which is/are given to each of the one or a plurality of similar objects and which has/have been predicted by a prediction model. Therefore, according to the information processing method S1 in accordance with the present example embodiment, it is possible to obtain an effect of making it possible to determine a label to be given to an object with high accuracy even in a case where only a single prediction model exists.

### Second Example Embodiment

A second example embodiment of the present invention will be described in detail with reference to the drawings. The same reference numerals are given to constituent elements which have functions identical with those described in the first example embodiment, and descriptions as to such constituent elements are not repeated.

### <Configuration of Information Processing Apparatus 1A>

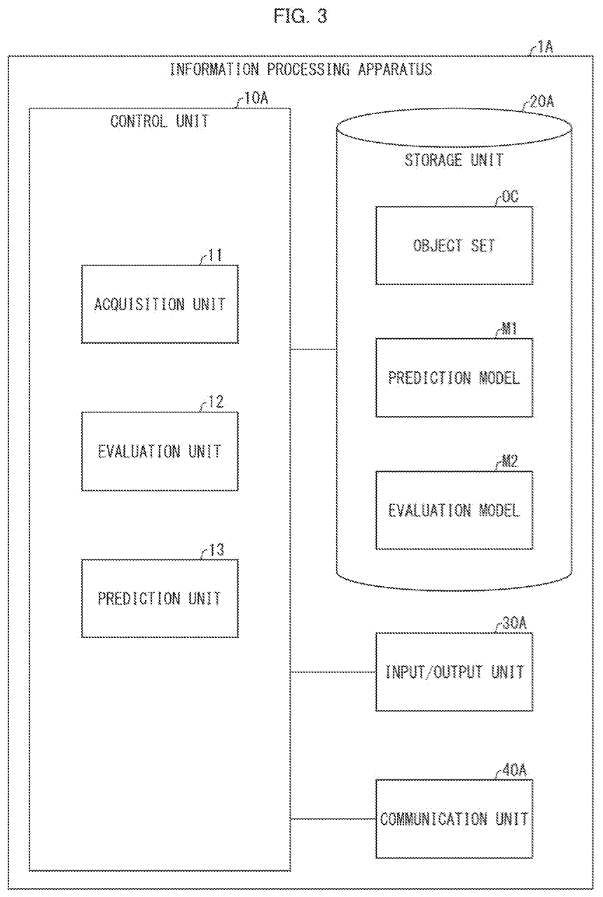

FIG. 3 is a block diagram illustrating a configuration of an information processing apparatus 1A in accordance with the present example embodiment. The information processing apparatus 1A includes a control unit 10A, a storage unit 20A, an input/output unit 30A, and a communication unit 40A.

### (Communication Unit 40A)

The communication unit 40A communicates with an apparatus outside the information processing apparatus 1A via a communication line. A specific configuration of the communication line is not intended to limit the present example embodiment. The communication line is, as an example, a wireless local area network (LAN), a wired LAN, a wide area network (WAN), a public network, a mobile data communication network, or a combination of these networks. The communication unit 40A transmits, to another apparatus, data supplied from the control unit 10A and supplies, to the control unit 10A, data received from another apparatus.

### (Input/Output Unit 30A)

To the input/output unit 30A, an input/output apparatus(es) such as a keyboard, a mouse, a display, a printer, and/or a touch panel is/are connected. The input/output unit 30A receives, from an input apparatus(es) connected thereto, an input of various pieces of information to the information processing apparatus 1A. The input/output unit 30A outputs, to an output apparatus(es) connected thereto, various pieces of information under control by the control unit 10A. Examples of the input/output unit 30A include an interface such as a universal serial bus (USB).

### (Control Unit 10A)

As illustrated in FIG. 3, the control unit 10A includes an acquisition unit 11, an evaluation unit 12, and a prediction unit 13.

### (Acquisition Unit 11)

The acquisition unit 11 acquires an object set. As an example, the acquisition unit 11 acquires a set of objects from another apparatus through the communication unit 40A. Alternatively, as an example, the acquisition unit 11 may acquire a set of objects inputted through the input/output unit 30A. Alternatively, the acquisition unit 11 may acquire a set of objects by reading the set of objects from the storage unit 20A or an externally connected storage apparatus.

### (Evaluation Unit 12)

The evaluation unit 12 evaluates the degree of similarity between objects included in the set of objects and identifies one or a plurality of similar objects which are similar to a prediction target object. Details of a process in which the evaluation unit 12 identifies a similar object(s) will be described later.

### (Prediction Unit 13)

The prediction unit 13 determines a label to be given to the prediction target object with reference to a similar label(s) that is/are a label(s) which is/are given to each of the one or a plurality of similar objects and which has/have been predicted by a prediction model M1. Details of a process in which the prediction 13 determines the label will be described later.

### (Storage Unit 20A)

The storage unit 20A stores an object set OC which is a set of objects acquired by the acquisition unit 11. Further, the storage unit 20A stores the prediction model M1 for predicting a label of an object and an evaluation model M2 for evaluating the degree of similarity between objects. Here, the expression “the prediction model M1 is stored in the storage unit 20A” means that parameters defining the prediction model M1 are stored in the storage unit 20A. Further, the expression “the evaluation model M2 is stored in the storage unit 20A” means that parameters defining the evaluation model M2 are stored in the storage unit 20A.

### (Prediction Model M1)

The prediction model M1 is a model that predicts a label of an object or a value included in the label. The prediction model M1 is, as an example, a prediction model that is constructed by machine learning so as to receive an input of a feature value of an object and output a label. The training of the prediction model M1 may be carried out by the control unit 10A of the information processing apparatus 1A or may be carried out by another apparatus. A method for machine learning of the prediction model M1 is not limited. The method may be, as an example, a decision tree-based method, a method using linear regression, or a method using a neural network. Alternatively, two or more of these methods may be used. Examples of the decision tree-based method include Light Gradient Boosting Machine (LightGBM), random forest, and XGBoost. Examples of the linear regression may include Bayesian regression, support vector regression, Ridge regression, Lasso regression, and ElasticNet. Examples of the neural network include deep learning.

The output from the prediction model M1 may include a plurality of labels and may also include a score representing the reliability of each of the labels.

As an example, the prediction model M1 is constructed by machine learning using training data including a pair made up of a feature value of an object and a label.

### (Evaluation Model M2)

The evaluation model M2 is a model for evaluating the degree of similarity between objects. The evaluation model M2 is, as an example, a model that performs clustering on objects. For the clustering performed on objects, for example, a technique such as, but not limited to, k-means clustering method or spectral clustering may be applied. In this case, it is possible to calculate the degree of similarity with use of the result of clustering performed by the evaluation model M2. In other words, it is possible to calculate, as the degree of similarity, whether or not clusters are identical on the basis of the result of clustering performed by the evaluation model M2.

The training of the evaluation model M2 may be carried out by the control unit 10A of the information processing apparatus 1A or may be carried out by another apparatus. The degree of similarity between objects is, as an example, a distance between objects in a feature value space in which the objects are embedded or a value calculated on the basis of the distance. Further, in a case where objects include character strings, a metric (Hamming distance, editing distance, or the like) related to whether or not the character strings match or the level of similarity defined between the character strings may be used as the degree of similarity between objects. In addition, the degree of similarity between objects may be expressed by, as an example, edges between nodes that represent objects. As an example, the presence of edges between the nodes indicates that the objects are similar, and the absence of edges between the nodes indicates that the objects are not similar. Such a graph structure may be given from the outside of the evaluation model M2 or may be stored as parameters of the evaluation model M2 in advance in the storage unit 20A or the like. However, the degree of similarity between objects is not limited to the examples described above.

### <Flow of Information Processing Method Carried out by Information Processing Apparatus 1A>

The flow of an information processing method carried out by the information processing apparatus 1A configured as described above will be described with reference to the drawing. Here, the following information processing methods S100 to S400 will be described as the information processing method carried out by the information processing apparatus 1A.
(i) The information processing method S100: The prediction unit 13 determines a label to be given to the prediction target object with reference to a similar label. At this time, the prediction unit 13 does not carry out prediction of the label of the prediction target object with use of the prediction model M1.
(ii) The information processing method S200: The prediction unit 13 predicts a yet-to-be-modified label of the prediction target object with use of the prediction model M1 and modifies the yet-to-be-modified label with reference to a similar label.
(iii) The information processing method S300: The prediction unit 13 determines a plurality of labels as the label to be given to the prediction target object.
(iv) The information processing method S400: The evaluation unit 12 outputs a graph or a hypergraph representing a similarity relationship between objects, and the prediction unit 13 uses the graph or the hypergraph to determine the label to be given to the prediction target object.

### (Flow of Information Processing Method S100)

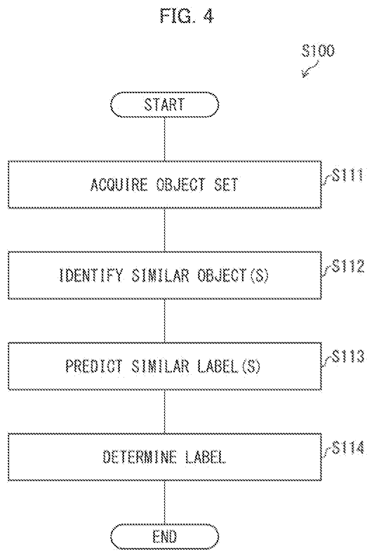

FIG. 4 is a flowchart illustrating a flow of the information processing method S100 which is an example of the information processing method carried out by the information processing apparatus 1A. Note that descriptions of the contents that have already been described will not be repeated.

### (Step S111)

In step S111, the acquisition unit 11 acquires the object set OC. As an example, the acquisition unit 11 may receive the object set OC from another apparatus through the communication unit 40A or may acquire the object set OC inputted through the input/output unit 30A. Alternatively, the acquisition unit 11 may acquire the object set OC by reading the object set OC from the storage unit 20A or an external storage apparatus.

### (Step S112)

In step S12, the evaluation unit 12 evaluates the degree of similarity between objects included in the object set OC and identifies one or a plurality of similar objects which are similar to a prediction target object. The prediction target object may be designated by a user operation, or the evaluation unit 12 may select the prediction target object from the object set OC on the basis of a predetermined selection condition.

In this example, the evaluation unit 12 evaluates the degree of similarity between objects with use of the evaluation model M2 and outputs a set of similar objects that are similar to the prediction target object. The degree of similarity evaluated by the evaluation unit 12 may be the degree of similarity between two objects or may be the degree of similarity among three or more objects. As an example, the evaluation unit 12 identifies, as the similar object(s), an object such that the degree of similarity of the object to the prediction target object is equal to or greater than a predetermined threshold value. Alternatively, as an example, the evaluation unit 12 may identify, as the similar object(s), an object that belongs to the same cluster as the prediction target object. Further, the evaluation unit 12 may give, to the similar object(s), weight information commensurate with the degree of similarity as additional information.

### (Step S113)

In step S113, the prediction unit 13 predicts a similar label with use of the prediction model M1. As an example, the prediction unit 13 regards a label obtained by inputting the feature value of a similar object into the prediction model M1 as a label to be given to the similar object, that is, the similar label. The similar label to be given to the similar object may be given a score representing the reliability of the label as additional information. The score given to the similar label is, as an example, a score output from the prediction model M1.

Further, a value of a single label may be given to one similar object, or values of a plurality of labels may be given to one similar object. As an example, the prediction unit 13 may determine, as the similar label(s), one or a plurality of labels whose reliability satisfies a predetermined condition among the plurality of labels predicted by the prediction model M1. The predetermined condition is, as an example, a condition such that, in a reliability ranking, a label is included in K (K is a natural number of 1 or more) top-ranked labels.

### (Step S114)

In step S114, the prediction unit 13 determines the label to be given to the prediction target object with reference to the similar label(s). As an example, the prediction unit 13 carries out statistical processing (majority decision, averaging, or the like) on a plurality of similar labels and determines, as the label to be given to the prediction target object, a similar label whose frequency satisfies a predetermined condition among the plurality of similar labels. Here, the predetermined condition includes, for example, a condition such that the frequency is the highest, a condition such that the frequency is equal to or greater than a threshold value, and a condition such that the frequency is included in K (K is a natural number of not less than 0) top-ranked total values.

Further, in step S114, a configuration may be employed in which the evaluation unit 12 calculates respective scores of the similar labels, and the prediction unit 13 determines the label to be given to the prediction target object with further reference to the scores calculated by the evaluation unit 12. In this case, the flow of the process in step S114 is such that the similar label(s) predicted by the prediction unit 13 in step S113 and the corresponding score(s) are passed to the evaluation unit 12, the evaluation unit 12 calculates a score(s) for each similar label in consideration of the degree of similarity, the score(s) calculated by the evaluation unit 12 is/are passed to the prediction unit 13, and the prediction unit 13 determines the label with reference to the score(s). As an example, the evaluation unit 12 may use the score of each label outputted by the prediction model M1 on an as-is basis as the score of the similar label or may calculate a score of the similar label with reference to the score of each label outputted by the prediction model M1. Further, as an example, the evaluation unit 12 may calculate the score with reference to the additional information given to the similar object by the evaluation unit 12. The score calculated by the evaluation unit 12 may be, as an example, a value representing a rank in terms of similarity or reliability. Further, the evaluation unit 12 may calculate the score of the similar label with reference to both the score outputted by the prediction model M1 and the additional information given to the similar object. In other words, the score calculated by the evaluation unit 12 for each similar label may be a value corresponding to the reliability of the label or may be a value corresponding to the degree of similarity between the prediction target object and the similar object.

In this case, as an example, the prediction unit 13 may determine, as the label to be given to the prediction target object, a similar label that is given a total score value which satisfies a predetermined condition. Here, the predetermined condition includes, for example, a condition such that the total value is largest, a condition such that the total value is equal to or greater than a threshold value, and a condition such that the total value is included in K (K is a natural number of not less than 0) top-ranked total values.

In addition, in a case where information indicative of a rank is given as the additional information, the prediction unit 13 may, as an example, determine a mean reciprocal rank (MRR) for each label from respective ranks of the respective similar objects and determine a label having the highest MRR as the label to be given to the prediction target object.

By the information processing apparatus 1A carrying out the information processing method S100, a label to be given to one prediction target object is determined. The information processing apparatus 1A may be configured to not only determine a label for one prediction target object, but also determine labels for a plurality of objects by repeatedly carrying out the information processing method S100. For example, after a label has been determined by carrying out the information processing method S100 with the object OBJ_A regarded as the prediction target object, the determined label for the object OBJ_A may be used to determine a label for the object OBJ_B, which is different from the object OBJ_A, by carrying out the information processing method S100 with the object OBJ_B regarded as the prediction target object.

### (Specific Example of Information Processing Method S100)

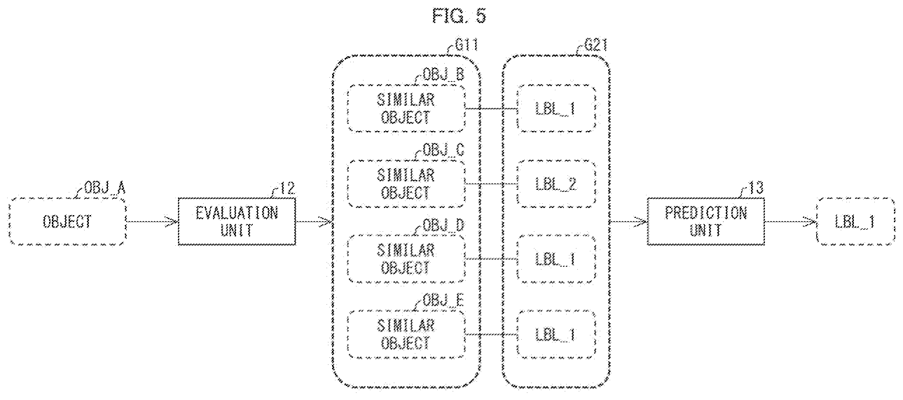

FIG. 5 is a view for describing a specific example of a process that is carried out by the evaluation unit 12 and the prediction unit 13 in the information processing method S100. Note that an arrow in the drawing simply indicates a direction of a flow of certain data and is not intended to eliminate bidirectionality. In the example of FIG. 5, the evaluation unit 12 identifies a set G11 of similar objects for the object OBJ_A (step S112). The set G11 includes similar objects OBJ_B to OBJ_E. Similar objects OBJ_B, OBJ_C, OBJ_D, and OBJ_E are given similar labels LBL_1, LBL_2, LBL_1, and LBL_1, respectively (step S113).

The prediction unit 13 determines the label to be given to the object OBJ_A with reference to the similar labels LBL_1 and LBL_2 that are labels given to the similar objects OBJ_B to OBJ_E (step S114). As an example, the prediction unit 13 determines, as the label to be given to the object OBJ_A, the similar label LBL_1, which is a label such that the frequency is the highest, among similar labels included in a similar label group G21, which is a set of similar labels.

### (Flow of Information Processing Method S200)

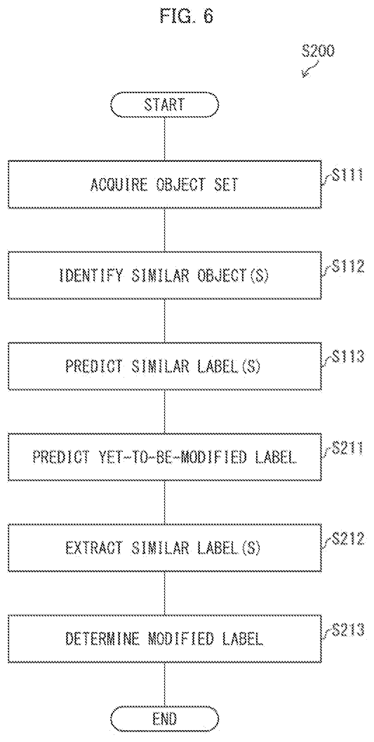

FIG. 6 is a flowchart illustrating a flow of the information processing method S200 which is an example of the information processing method carried out by the information processing apparatus 1A. In the information processing method S200, the prediction unit 13 modifies a yet-to-be-modified label of the prediction target object with reference to similar labels. The information processing method S200 includes steps S211 to S213 in addition to steps S111 to S113. Note that descriptions of the contents that have already been described will not be repeated. The steps included in the information processing method S200 may be carried out in parallel or in a different order. For example, a process in step S211 may be carried out before step S112.

### (Step S211)

In step S211, the prediction unit 13 predicts a yet-to-be-modified label of the prediction target object with use of the prediction model M1. More specifically, the prediction unit 13 predicts the yet-to-be-modified label by inputting the feature value of the prediction target object into the prediction model M1. The yet-to-be-modified label may be given a score representing the reliability of the label as additional information.

### (Step S212)

In step S212, the evaluation unit 12 extracts one or more similar labels from a plurality of similar labels given to a plurality of similar objects. As an example, the evaluation unit 12 extracts a similar label(s) that appear(s) the number of times which are equal to or more than a predetermined number of times from among a plurality of similar labels. At this time, the evaluation unit 12 may extract the similar label(s) with reference to additional information given to the similar label. As an example, the evaluation unit 12 may extract a similar label such that the MRR of the similar label is equal to or greater than the threshold value. However, a method for extracting the similar label(s) is not limited to the above-described examples. The evaluation unit 12 may extract the similar label(s) by other method. Hereinafter, the similar label extracted by the evaluation unit 12 is also referred to as “modification candidate label”. Further, a set of one or a plurality of modification candidate labels is also referred to as “modification candidate label set”. The number of modification labels included in the modification candidate label set may be one or may be more than one.

### (Step S213)

In step S213, the prediction unit 13 determines, as the label to be given to the prediction target object, a modified label that is obtained by modifying a yet-to-be-modified label with reference to the similar label. As an example, in a case where the yet-to-be-modified label is included in the set of similar labels, the prediction unit 13 determines the yet-to-be-modified label on an as-is basis as the modified label. On the other hand, in a case where the yet-to-be-modified label is not included in the set of similar labels, the prediction unit 13 determines, as the modified label, a similar label that satisfies a predetermined condition from among the similar labels. The predetermined condition includes, as an example, a condition such that the frequency is the highest, a condition such that the frequency is equal to or greater than a threshold value, and a condition such that, in a frequency ranking, a label is included in K top-ranked labels.

At this time, in step S213, the prediction unit 13 may carry out a comparison between the one or more similar labels having been extracted in step S212 and the yet-to-be-modified label to determine the modified label. As an example, in a case where the yet-to-be-modified label is included in the modification candidate label set, the prediction unit 13 determines the yet-to-be-modified label as the modified label. On the other hand, in a case where the yet-to-be-modified label is not included in the modification candidate label set, the prediction unit 13 determines, as the modified label, a modification candidate label that satisfies a predetermined condition from among the modification candidate labels. The predetermined condition includes, as an example, a condition such that the frequency is the highest, a condition such that the frequency is equal to or greater than a threshold value, and a condition such that, in a frequency ranking, a label is included in K top-ranked labels.

Further, the prediction unit 13 may determine the label to be given to the prediction target object with reference to additional information given to each of the modification candidate labels. As an example, in a case where the yet-to-be-modified label is not included in the modification candidate label set, the prediction unit 13 may determine the MRRs of the modification candidate labels and determine, as the label to be given to the prediction target object, a modification candidate label having the highest MRR.

By the information processing apparatus 1A carrying out the information processing method S200, a label to be given to one prediction target object is determined. The information processing apparatus 1A may be configured to determine labels for a plurality of objects by repeatedly carrying out the information processing method S200.

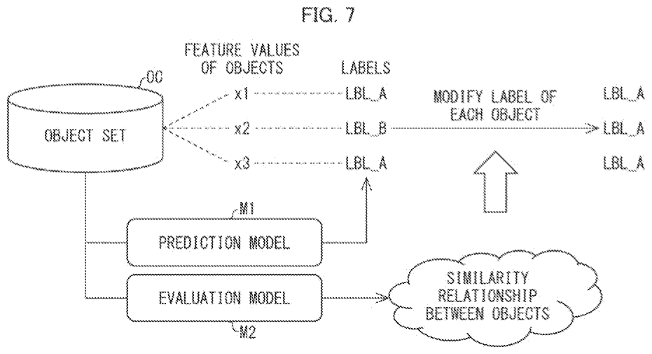

FIG. 7 is a view schematically illustrating a process that is carried out by the evaluation unit 12 and the prediction unit 13 in the information processing method S200. Note that an arrow in the drawing simply indicates a direction of a flow of certain data and is not intended to eliminate bidirectionality. In the example of FIG. 7, the prediction unit 13 predicts the labels for the objects OBJ_1, OBJ_2, and OBJ_3 included in the object set OC by inputting the feature values x1, x2, and x3 of the objects OBJ_1, OBJ_2, and OBJ_3 into the prediction model M1. The prediction model M1 predicts that the labels for the objects OBJ_1, OBJ_2, and OBJ_3 are LBL_A, LBL_B, and LBL_A, respectively.

Further, the evaluation unit 12 evaluates the similarity relationship between the objects included in the object set OC and identifies a similar object for the prediction target object. The prediction unit 13 determines the label to be given to the prediction target object with reference to similar labels that are given to the similar objects having been identified by the evaluation unit 12. In the example of FIG. 7, the labels for the objects OBJ_1 and OBJ_3 are not modified and remain as “LBL_A”, but the label for the object OBJ_2 is modified from “LBL_B” to “LBL_A”.

### (Specific Example of Information Processing Method S200)

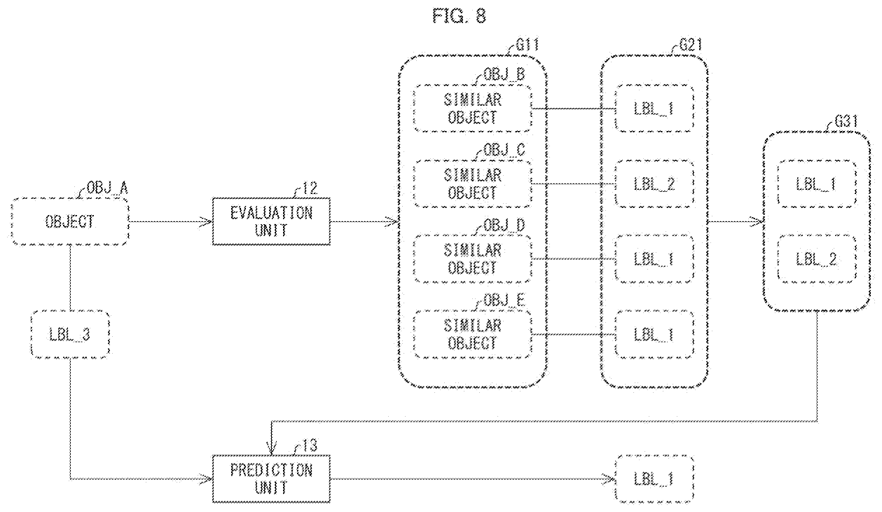

FIG. 8 is a view for describing a specific example of a process that is carried out by the evaluation unit 12 and the prediction unit 13 in the information processing method S200. Note that an arrow in the drawing simply indicates a direction of a flow of certain data and is not intended to eliminate bidirectionality. In the example of FIG. 8, the evaluation unit 12 identifies a set G11 of similar objects for the object OBJ_A (S112). The set G11 includes similar objects OBJ_B to OBJ_E. Similar objects OBJ_B, OBJ_C, OBJ_D, and OBJ_E are given similar labels LBL_1, LBL_2, LBL_1, and LBL_1, respectively (step S113).

In addition, in the example of FIG. 8, the prediction model M1 predicts that the label LBL_3 is the label for the object OBJ_A (step S211). The prediction unit 13 extracts a similar label group G31 including the similar labels LBL_1 and LBL_2 from the similar label group G21 (step S212) and determines the label to be given to the object OBJ_A from the extracted similar label group G31 (step S213). In the example of FIG. 8, the prediction unit 13 determines, as a label to be given to a prediction target object OBJ_A, the similar label LBL_1 included in the similar label group.

### (Flow of Information Processing Method S300)

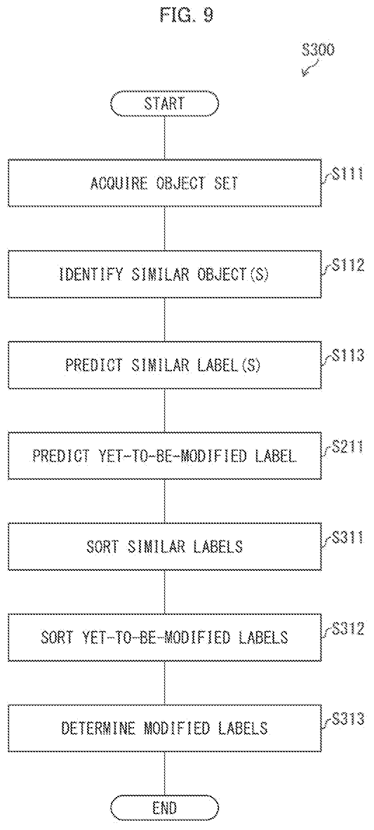

FIG. 9 is a flowchart illustrating a flow of the information processing method S300 which is an example of the information processing method carried out by the information processing apparatus 1A. The information processing method S300 includes steps S311 to S313 in addition to steps S111 to S113 and step S211. Note that descriptions of the contents that have already been described will not be repeated. The steps included in the information processing method S300 may be carried out in parallel or in a different order. For example, a process in step S211 may be carried out earlier than a process in step S112.

### (Step S311)

In step S311, the prediction unit 13 sorts the plurality of similar labels given to the plurality of similar objects with reference to the plurality of similar labels given to each of the plurality of similar objects and the respective scores of the similar labels. As an example, the prediction unit 13 calculates values of the MRRs from respective ranks of the similar objects (ranks indicated by the additional information) and sorts the similar labels with use of the calculated values. Note that the value that is used for sorting of the similar labels by the prediction unit 13 is not limited to MRR and may be other value.

For example, the prediction unit 13 may calculate an average value of the scores of the similar labels (or the similar objects) and sort the similar labels on the basis of the calculated average value. Further, for example, the prediction unit 13 may extract K top-ranked similar labels for each similar object as a top-ranked label set and sort the similar labels according to the frequencies of these extracted labels included in the top-ranked label set.

In step S311, the prediction unit 13 may further sort the plurality of similar labels given to the plurality of similar objects with reference to a hierarchical relationship between the plurality of similar labels. The hierarchical relationship may be given by a predetermined database, or the prediction unit 13 may generate the hierarchical relationship between the similar labels from data such as objects on the basis of the objects. As a method for generating the hierarchical relationship, as an example, the method described in the literature ‘Wu, Wentao, et al. “Probase: A probabilistic taxonomy for text understanding.” Proceedings of the 2012 ACM SIGMOD International Conference on Management of Data. 2012’ may be used. In this case, the prediction unit 13 may sort the similar labels so that a similar label in a higher hierarchical level is ranked in a higher place.

Specifically, for example, assume that a plurality of similar labels predicted by the prediction unit 13 include similar labels “person”, “president”, “politician”, and “businessman”, and a hierarchical relationship is given in which the similar label “person” is placed in a higher hierarchical level than the similar labels “president”, “politician”, and “businessman”. In this case, as an example, the prediction unit 13 sort the similar labels so that the similar label “person” is ranked in a higher place than the similar labels “president”, “politician”, and “businessman”.

### (Step S312)

In step S312, the prediction unit 13 sorts a plurality of yet-to-be-modified labels related to the target object with reference to the plurality of yet-to-be-modified labels related to the target object and the respective scores of the yet-to-be-modified labels. As an example, the prediction unit 13 sorts the yet-to-be-modified labels in descending order of the added scores. Note that a method by which the prediction unit 13 carries out sorting is not limited to the above-described examples and may be other method. Further, in step S312, the prediction unit 13 may carry out sorting with reference to the hierarchical relationship between the plurality of labels in a manner similar to step S311.

### (Step S313)

In step S313, the prediction unit 13 determines, as the modified labels, the yet-to-be-modified labels included in M (M is a natural number) top-ranked similar labels given to the plurality of similar objects among N (N is a natural number) top-ranked yet-to-be-modified labels related to the target object.

The information processing method S300 enables the information processing apparatus 1A to determine, with higher accuracy, a plurality of labels to be given to one prediction target object.

However, in step S313, the prediction unit 13 may determine the modified labels with reference to the similar labels without reference to the yet-to-be-modified labels. In this case, as an example, the prediction unit 13 may determine, as the modified labels, a set of M top-ranked similar labels sorted in step S311.

### (Flow of Information Processing Method S400)

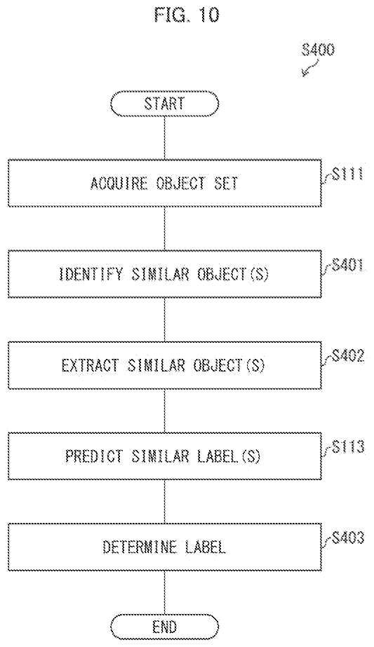

FIG. 10 is a flowchart illustrating a flow of the information processing method S400 which is an example of the information processing method carried out by the information processing apparatus 1A. In the information processing method S400, the evaluation unit 12 outputs a graph or a hypergraph representing a similarity relationship between objects, and the prediction unit 13 uses the graph or the hypergraph to determine the label to be given to the prediction target object. The information processing method S400 includes steps S401 to S403 in addition to steps S111 and S113. Note that descriptions of the contents that have already been described will not be repeated.

### (Step S401)

In step S401, the evaluation unit 12 identifies one or more similar objects by outputting a graph representing a similarity relationship between the objects. The graph outputted by the evaluation unit 12 is, as an example, a graph or a hypergraph that regards the objects as nodes and that has an edge or a hyperedge connecting the nodes which have been evaluated in terms of the degree of similarity. More specifically, the graph or the hypergraph is, as an example, a graph that has an edge or a hyperedge between objects having a similar relationship and has no edge or hyperedge between objects having no similar relationship. Further, the edge or the hyperedge may be given weight information commensurate with the degree of similarity between the corresponding nodes.

### (Step S402)

In step S402, the prediction unit 13 extracts one or a plurality of similar objects from the object set OC with reference to the graph outputted by the evaluation unit 12. As an example, the prediction unit 13 extracts one or more similar objects that exist within a predetermined number of hops from the prediction target object with reference to the graph outputted by the evaluation unit 12. As an example, the evaluation unit 12 extracts a similar object(s) connected to the prediction target object through an edge or a hyperedge up to k edges or hyperedges.

### (Step S403)

In step S403, the prediction unit 13 determines the label to be given to the prediction target object with reference to the similar label(s) given to the extracted one or more similar objects.

However, a method in which the prediction unit 13 determines the label is not limited to the above-described examples. As an example, the prediction unit 13 may determine the label with use of a neural network (graph neural network) that can carry out calculation allowing for the structure of the graph or the hypergraph. As the graph neural network, for example, the neural network described in the literature ‘Schlichtkrull, Michael, et al. “Modeling relational data with graph convolutional networks.” European Semantic Web Conference. Springer, Cham, 2018’ or the literature ‘Feng, Yifan, et al. “Hypergraph neural networks.” Proceedings of the AAAI Conference on Artificial Intelligence. Vol. 33. 2019’ may be used.

In the training of the graph neural network, a node corresponding to each object is given a feature value of the object, and each edge or hyperedge is given a degree of similarity between the corresponding objects as the feature value so that a model such as the graph neural network is trained to predict a label for each node. In this training, some or all of the yet-to-be modified labels may be utilized as training data for labels to be predicted by the graph neural network. In this case, the prediction unit 13 determines a label of a prediction target object corresponding to each node on the basis of the label that has been predicted by the above-described model.

### (Effect of Information Processing Apparatus 1A)

As described above, in the information processing apparatus 1A in accordance with the present example embodiment, a configuration is employed in which respective scores of similar labels are calculated, and the labels to be given to the prediction target object are determined with further reference to the calculated scores. According to the information processing apparatus 1A in accordance with the present example embodiment, by the information processing apparatus 1A calculating scores according to, for example, the reliability of similar labels or the degree of similarity of similar objects, it is possible to obtain, in addition to the effect brought about by the information processing apparatus 1 in accordance with the first example embodiment, an effect of making it possible to carry out determination of a label with consideration given to, for example, the reliability of similar labels.

In addition, in the information processing apparatus 1A in accordance with the present example embodiment, a configuration is employed in which a yet-to-be-modified label of the prediction target object is predicted by a prediction model, and the yet-to-be-modified label is modified with reference to a similar label. Thus, according to the information processing apparatus 1A in accordance with the present example embodiment, it is possible to obtain, in addition to the effect brought about by the information processing apparatus 1 in accordance with the first example embodiment, an effect of making it possible to modify a yet-to-be-modified label with high accuracy.

### Third Example Embodiment

A third example embodiment of the present invention will be described in detail with reference to the drawings. The same reference numerals are given to constituent elements which have functions identical with those described in the first and second example embodiments, and descriptions as to such constituent elements are not repeated.

The information processing apparatus 1B in accordance with the present example embodiment classifies entities in a sentence written in a natural language. The entity is a character string representing a specific concept or a specific object, and is, as an example, a proper noun or a general noun. As an example, entities in the sentence of “Mr. Joe Taylor is the U.S. president.” are “Mr. Joe Taylor”, “the U.S.”, and “president”. The entity is classified as classes. The classes indicate results of classification of an entity and are, for example, “person”, “company”, and “nation”. One entity is annotated with one or more classes. In other words, one entity may be annotated with one or more classes.

### <Configuration of Information Processing Apparatus 1B>

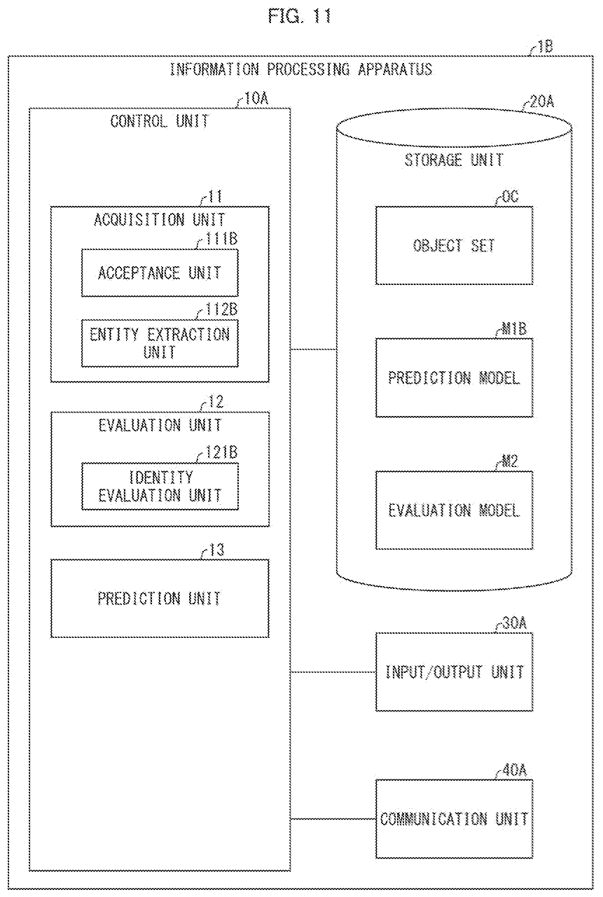

FIG. 11 is a block diagram illustrating the configuration of the information processing apparatus 1B. The information processing apparatus 1B includes a control unit 10A, a storage unit 20A, an input/output unit 30A, and a communication unit 40A. An acquisition unit 11 of the control unit 10A includes an acceptance unit 111B and an entity extraction unit 112B. Further, the evaluation unit 12 includes an identity evaluation unit 121B. Further, the storage unit 20A stores a prediction model M1B, in addition to the object set OC and the evaluation model M2.

### (Acceptance Unit 111B)

The acceptance unit 111B accepts a sentence set. The sentence set includes one or more sentences. As an example, the acceptance unit 111B may accept a sentence set from another apparatus through the communication unit 40A. Further, the acceptance unit 111B may acquire, as an example, a sentence set inputted through the input/output unit 30A. Further, the acceptance unit 111B may acquire a sentence set by reading the sentence set from the storage unit 20A or an externally connected storage apparatus.

### (Entity Extraction Unit 112B)

The entity extraction unit 112B extracts a plurality of entities from a sentence set. As an example, the entity extraction unit 112B carries out natural language processing (morphological analysis, N-gram analysis, or the like) on sentences included in a sentence set and extracts entities included in each sentence. More specifically, as an example, the entity extraction unit 112B carries out syntactic analysis on sentences and extracts, as entities, character strings that match a predetermined grammar pattern such as a noun clause and an adjective clause. Alternatively, the entity extraction unit 112B may extract, as an entity, a character string that is checked against a character string in a preset dictionary. Alternatively, the entity extraction unit 112B may extract an entity with use of the technique described in the literature ‘Shang, Jingbo, et al. “Automated phrase mining from massive text corpora,” IEEE Transactions on Knowledge and Data Engineering 30.10 (2018): 1825-1837’.

### (Acquisition Unit 11)

The acquisition unit 11 acquires, as a set of objects, a combination of the plurality of entities that have been extracted by the entity extraction unit 112B and the sentences from which the plurality of entities have been extracted. An object is represented by, as an example, a feature value that is a character string representing a sentence and a position of an entity in the character string. For example, in a case where a character string in a sentence d is “Mr. Joe Taylor is the U.S. president.”, and an entity is “Mr. Joe Taylor”, the feature value is represented by, as an example, (sentence d, <first character to eighth character>).

In the present example embodiment, entities appearing in different sentences are treated as different objects even through the entities are character strings representing the same substance. For example, in a case where there are the following two sentences: “Mr. Joe Taylor was elected.”; and “Mr. Joe Taylor is the U.S. president.”, respective objects are created for these two character strings “Mr. Joe Taylor”.

Note that the set of objects that the acquisition unit 11 acquires is not limited to the above-described examples. The set of objects may be, as an example, a plurality of entities that are extracted by the entity extraction unit 112B.

### (Identity Evaluation Unit 121B)

The identity evaluation unit 121B evaluates identity between objects included in the set of objects and identifies, as a similar object, an object that is identical to the prediction target object. As an example, the identity evaluation unit 121B, with reference to the feature values of a plurality of objects, evaluates whether entities corresponding to the objects refer to the same substance (thing or matter).

Specifically, the identity evaluation unit 121B evaluates identity between objects by the following method. The identity evaluation unit 121B first acquires a character string of an entity corresponding to an object with reference to the feature value of the object. The character string of the entity can be acquired from a sentence and a character string position, which are a feature value. The identity evaluation unit 121B sets the degree of similarity between objects such that acquired character strings are identical to “1” and sets the degree of similarity between objects such that acquired character strings are not identical to “0”.

However, a method by which the identity evaluation unit 121B evaluates identity between objects is not limited to the above-described example, and other method may be used. As an example, the identity evaluation unit 121B may identify an instance in a knowledge base corresponding to an entity corresponding to each object by use of the method described in the literature ‘Wu, Ledell, et al., “Scalable zero-shot entity retrieval,” linking with dense entity arXiv preprint arXiv: 1911.03814 (2019)’. In this case, as an example, the identity evaluation unit 121B sets the degree of similarity between objects such that the same instance has been identified to “1” and sets the degree of similarity between objects such that the same instance has not been identified to “0”.

### (Prediction Model M1B)

The prediction model M1B is a model for predicting a label of an object. In the present example embodiment, a label given to an object is a set of classes as which the object is classified. A class can be represented by, for example, a character string or an integer ID. For example, in a case where the feature value of the object is the above-described (sentence d, <first character to eighth character>), the label is, as an example, a set of classes such as {person, president, politician, male, father, American}.

The prediction model M1B is, as an example, a language model that is constructed by unsupervised learning. In this case, the language model is, as an example, a model that outputs a degree of confidence as the natural language sentence in a word string inputted thereinto. Use of such a language model makes it also possible to predict a word with which the word string that has been inputted into the language model is complemented. The word with which the word string is complemented is a word that can allow the word string obtained by complementing the word string with the word to be the natural language sentence. As the prediction model M1B, for example, the model described in the literature ‘Devlin, Jacob, et al., “Bert: Pre-training of deep bidirectional transformers for language understanding,” arXiv preprint arXiv: 1810.04805 (2018)’ is applicable.

### <Flow Of Information Processing Method Carried out by Information Processing Apparatus 1B>

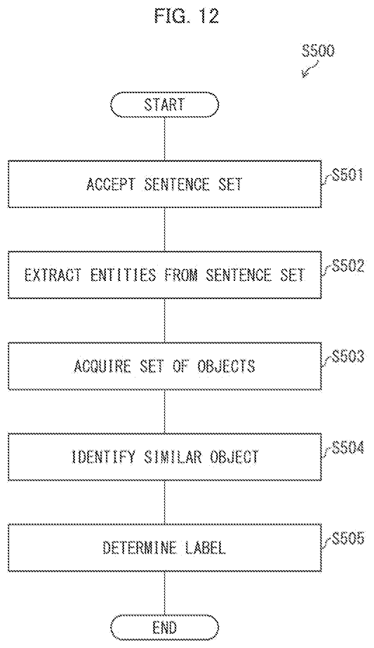

The flow of an information processing method S500 which is an example of the information processing method carried out by the information processing apparatus 1B configured as described above will be described with reference to FIG. 12. FIG. 12 is a flowchart illustrating a flow of the information processing method S500. Note that descriptions of the contents that have already been described will not be repeated.

### (Steps S501 and S502)

In step S501, the acceptance unit 111B accepts a sentence set. In step S502, the entity extraction unit 112B extracts a plurality of entities from the sentence set. Specifically, for example, the entity extraction unit 112B extracts “Mr. Joe Taylor”, “the U.S.”, and “president” as entities from the sentence “Mr. Joe Taylor is the U.S. president.”.

### (Step S503)

In step S503, the acquisition unit 11 acquires, as the set of objects, a pair made up of the plurality of entities that have been extracted by the entity extraction unit 112B and the sentence from which the plurality of entities have been extracted.

### (Step S504)

In step S504, the identity evaluation unit 121B evaluates identity between objects included in the set of objects and identifies, as a similar object, an object that is identical to the prediction target object.

### (Step S505)

In step S505, the prediction unit 13 determines a label to be given to the prediction target object with reference to a similar label given to a similar object. An example of a method by which the prediction unit 13 determines the label in accordance with the present example embodiment will be described below.

First, the prediction unit 13 predicts a yet-to-be-modified label of the prediction target object with use of the prediction model M1B. First, the prediction unit 13 creates a character string with a blank provided in a part of the character string that is the entity on the basis of the feature value of an object. The prediction unit 13 creates, as an example, a character string “<MASK> is the U.S. president.” from the sentence d “Mr. Joe Taylor is the U.S. president.”. In this character string, “<MASK>” represents a blank. Then, the prediction unit 13 treats a class name as a word and uses the prediction model M1B to calculate the degree of confidence in each class name fitting in the blank in the form of a score. As an example, the prediction unit 13 calculates the respective degrees of confidence in the classes “person” and “nation” as a score of “0.9” for the “person” fitting in the blank and as a score of “0.1” for the “nation” fitting in the blank.

Note that, in creating a character string with a blank provided in a part of the character string that is the entity, the prediction unit 13 may not only simply provide a blank corresponding to the entity but also modify a part of a sentence so that a class name is more likely to fit in the blank. For example, the prediction unit 13 may create a character string “The <MASK> is the U.S. president.” from the sentence d. As long as the sentence is modified so that the class name is more likely to fit in the blank, the prediction unit 13 does not necessarily need to provide the blank in the part of the character string that is the entity. For example, the prediction unit 13 may create a character string “<MASK> such as Mr. Joe Taylor is the U.S. president.” from the sentence d.

As described above, the prediction unit 13 predicts, as the yet-to-be-modified label, a set of pairs each made up of a class name and a score with use of the prediction model M1B. A similar label to be given to a similar object is also predicted with use of the prediction model M1B in the same manner as the yet-to-be-modified label. That is, in the present example embodiment, the similar label is a set of pairs each made up of a class name and a score. The similar label may be predicted by the prediction unit 13 or may be predicted by another apparatus other than the information processing apparatus 1B.

The prediction unit 13 determines the yet-to-be-modified label with reference to the similar label. A method for determining the yet-to-be-modified label with use of the similar label is similar to the method described in the above-described second example embodiment.

As an example, the prediction unit 13 determines the yet-to-be-modified label by the above-described information processing method S300. In this case, more specifically, the prediction unit 13 calculates ranks of the classes (“nation”, “person”, and others) included in the similar labels for the similar objects OBJ_B, OBJ_C, OBJ_D, and OBJ_E of the modification target object OBJ_A, calculates MRRs of the classes from the obtained ranks, and sorts the similar labels according to values of the MRRs (step S311). Note that the value that is used for sorting of the classes by the prediction unit 13 is not limited to MRR and may be other value. For example, the prediction unit 13 may carry out sorting on the basis of an average value of the scores corresponding to the classes.

Next, in step S312, the prediction unit 13 carries out a process of sorting the plurality of classes included in the yet-to-be-modified label on the basis of the scores. Further, the prediction unit 13 determines, as the modified label, a set of M top-ranked classes sorted in step S311 among N top-ranked classes sorted in step S312 (step S313). However, a method of determining the modified label is not limited to this method, and other method may be used. As an example, the prediction unit 13 may determine, as the modified label, the set of M top-ranked classes sorted in step S311, without reference to the yet-to-be-modified label.

In addition, in step S311 and step S312, the prediction unit 13 may carry out sorting of a plurality of classes with reference to the hierarchical relationship between the classes, as described above. Examples of a lower class of the class “person” include “president”, “politician”, “businessman”, and the like. In this case, as an example, the prediction unit 13 carries out sorting by replacing a score of each class with the largest score among scores of the lower classes of the class. Alternatively, as an example, the prediction unit 13 may carry out sorting so that a higher class comes before a lower class.

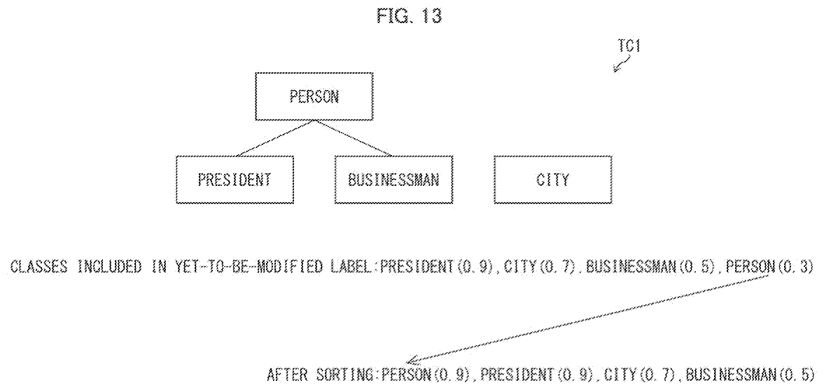

FIG. 13 is a view illustrating a specific example of the hierarchical relationship of the classes and sorting carried out by the prediction unit 13. In FIG. 13, it is shown that a hierarchical relationship TC1 has classes “PRESIDENT” and “BUSINESSMAN” which are lower than the class “PERSON”. Further, in FIG. 13, a yet-to-be-modified label includes classes “PRESIDENT”, “CITY”, “BUSINESSMAN”, and “PERSON”, and the scores of the classes are calculated as “0.9”, “0.7”, “0.5”, and “0.3”, respectively.

Since the class “PERSON” is higher than the class “PRESIDENT” in the hierarchical relationship TC1 between the classes, the prediction unit 13 changes the score of the class “PERSON” from “0.3” to “0.9”, and carries out sorting so that the rank of the class “PERSON” becomes higher than the rank of the class “PRESIDENT”.

### (Effect of Information Processing Apparatus)

As described above, in the information processing apparatus 1B in accordance with the present example embodiment, a plurality of entities are extracted from a sentence set, and labels to be given to the objects including the extracted entities are determined. Thus, according to the information processing apparatus 1B in accordance with the present example embodiment, for an entity extracted from a sentence, it is possible to determine a label to be given to an object including the entity with high accuracy.

In addition, in the information processing apparatus 1B in accordance with the present example embodiment, a configuration is employed in which identity between objects is evaluated, and an object which is identical to a prediction target object is identified as a similar object. Therefore, according to the information processing apparatus 1B in accordance with the present example embodiment, the evaluation of identity between objects makes it possible to determine a label to be given to a prediction target object with higher accuracy.

### Fourth Example Embodiment

A fourth example embodiment of the present invention will be described in detail with reference to the drawing. The same reference numerals are given to constituent elements which have functions identical with those described in the first to third example embodiments, and descriptions as to such constituent elements are not repeated.

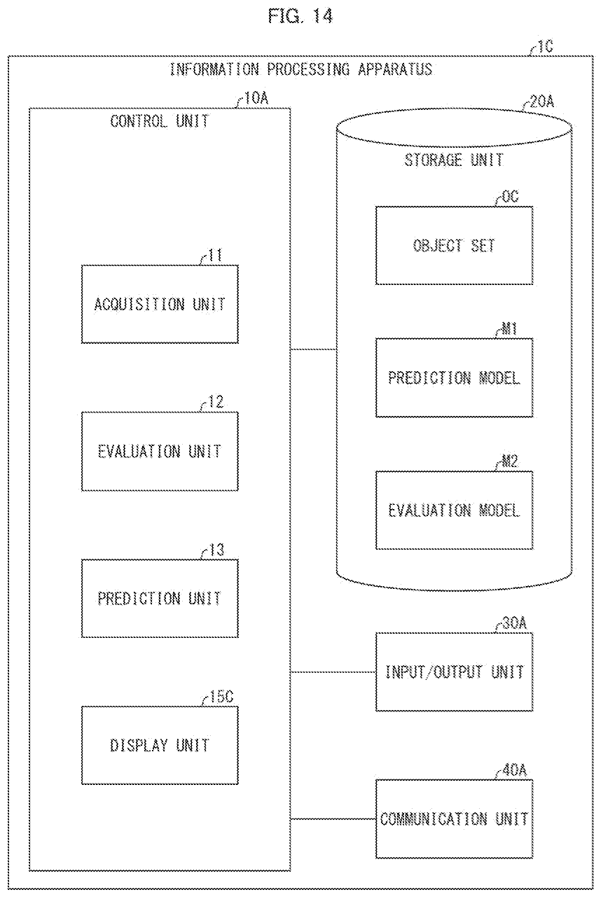

FIG. 14 is a block diagram illustrating a configuration of an information processing apparatus 1C in accordance with the present example embodiment. The information processing apparatus 1C includes a control unit 10A, a storage unit 20A, an input/output unit 30A, and a communication unit 40A. The control unit 10A includes a display unit 15C, in addition to an acquisition unit 11, an evaluation unit 12, and a prediction unit 13.

The display unit 15C displays various screens by outputting data representing a display screen to a display apparatus connected to the input/output unit 30A. The display apparatus includes, as an example, a liquid crystal display or a projector. As an example, the display unit 15C displays a prediction target object. The display unit 15C also displays at least one of similar objects or at least one of similar labels.

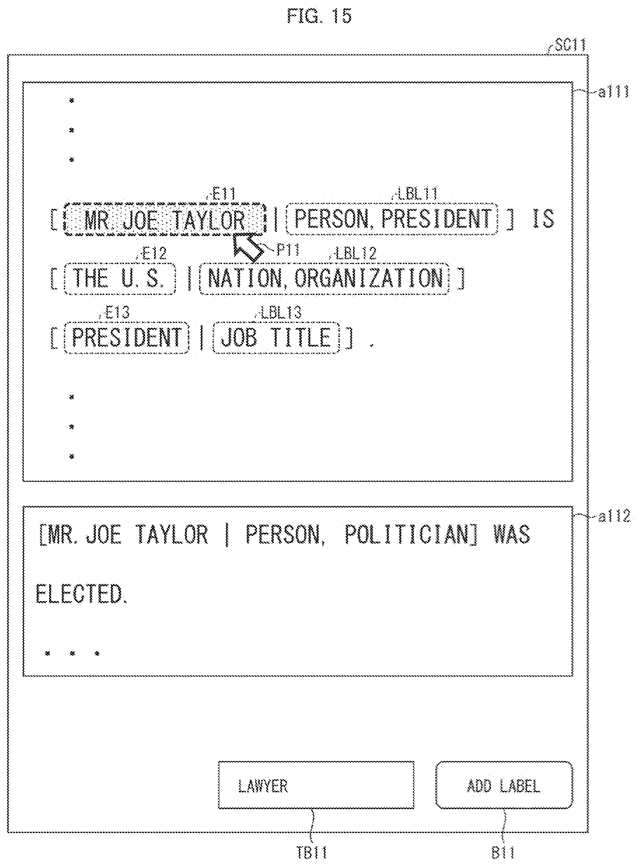

FIG. 15 is a view illustrating a screen SC11 that is an example of a screen displayed by the display unit 15C. The screen SC11 includes a first area a111 and a second area a112. In the first area all1, sentences and entities included in a prediction target object are displayed. In addition, displayed in the first area al11 are classes that are included in labels which have been determined by the prediction unit 13 and that correspond to entities. Specifically, “PERSON” and “PRESIDENT” are displayed as a label LBL11 of an entity E11 “MR. JOE TAYLOR”, and “NATION” and “ORGANIZATION” are displayed as a label LBL12 of an entity E12 “THE U.S.”. In addition, “JOB TITLE” is displayed as a label LBL13 of an entity E13 “PRESIDENT”.

In the second area a112, sentences and entities included in a similar object are displayed. In addition, displayed in the second area a112 are classes that are included in a similar label for the similar object and that correspond to an entity included in the similar object. For example, “PERSON” and “POLITICIAN” are displayed as classes of an entity “MR. JOE TAYLOR”.

Further, the screen SC11 also includes a text box TB11 and a button B11. The text box TB11 is a text box for allowing the user of the information processing apparatus 1C to input a class name with use of an input apparatus (mouse, keyboard, or the like) connected to the input/output unit 30A. When the user selects an entity with use of a pointer P11, inputs a character string in the text box TB11, and carries out an operation of selecting the button B11, the information processing apparatus 1C adds the class name of the inputted character string to a label given to the prediction target object. In other words, with use of the input apparatus connected to the input/output unit 30A, the user can change the label given to the prediction target object by the prediction unit 13.

Further, the display unit 15C may display a yet-to-be-modified label of the prediction target object or a label given to a target object. In addition, at this time, the display unit 15C may display similar labels.

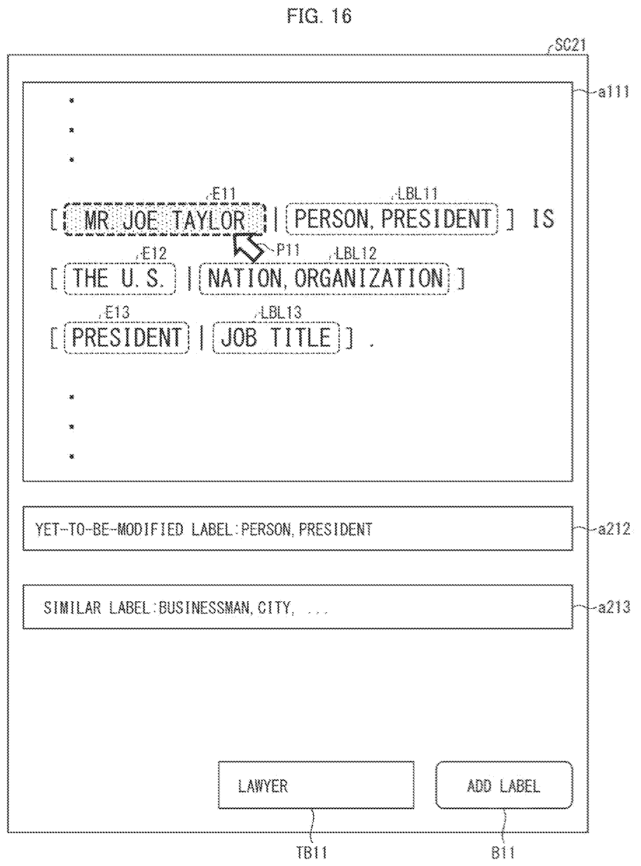

FIG. 16 is a view illustrating a screen SC21 that is an example of the screen displayed by the display unit 15C. The screen SC21 includes a first area a111, a fourth area a212, and a fifth area a213. In the first area a111, sentences and entities included in a prediction target object are displayed as in the screen S11. In addition, displayed in the first area alll are classes that are included in labels given to the prediction target object (i.e., labels which have been determined by the prediction unit 13) and that correspond to entities.

In the fourth area a212, a yet-to-be-modified label of the prediction target object is displayed. In the fifth area a213, a similar label is displayed. Further, on the screen SC21, like the screen SC11, a text box TB11 and a button B11 are displayed.

According to the present example embodiment, it is possible for the user of the information processing apparatus 1C to ascertain the prediction target object and the similar object or the similar label by checking the screen illustrated as an example in FIG. 15. In addition, it is also possible to change the label of the prediction target object with use of the input apparatus.

Further, according to the present example embodiment, it is possible to ascertain the yet-to-be-modified label of the prediction target object or the label given to the prediction target object and the similar label by checking the screen illustrated as an example in FIG. 16.

### [Software Implementation Example]

Some or all of functions of the information processing apparatuses 1, 1A, 1B, and 1C can be realized by hardware such as an integrated circuit (IC chip) or can be alternatively realized by software.

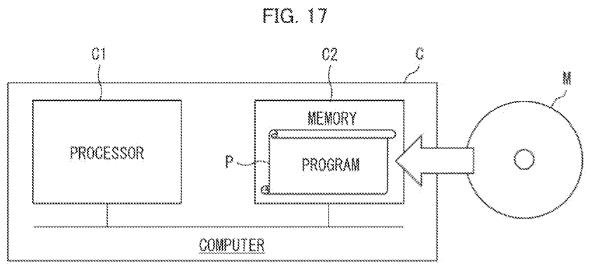

In the latter case, the information processing apparatuses 1, 1A, 1B, and 1C are each realized by, for example, a computer that executes instructions of a program that is software realizing the foregoing functions. FIG. 17 illustrates an example of such a computer (hereinafter, referred to as “computer C”). The computer C includes at least one processor C1 and at least one memory C2. The at least one memory C2 stores a program P for causing the computer C to operate as each of the information processing apparatuses 1, 1A, 1B, and 1C. In the computer C, the processor C1 reads the program P from the memory C2 and executes the program P, so that the functions of the information processing apparatuses 1, 1A, 1B, and 1C are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following example aspects.

### (Supplementary Note 1)

An information processing apparatus including:

an acquisition means for acquiring a set of objects;

an evaluation means for evaluating a degree of similarity between objects included in the set of objects and identifying one or a plurality of similar objects which are similar to a prediction target object; and

a prediction means for determining a label to be given to the prediction target object with reference to a similar label(s), the similar label(s) being a label(s) which is/are given to each of the one or a plurality of similar objects and which has/have been predicted by a prediction model.

According to the above-described configuration, it is possible to determine the label to be given to the prediction target object with high accuracy even in a case where only a single prediction model exists.

### (Supplementary Note 2)

The information processing apparatus described in supplementary note 1, wherein

the evaluation means is configured to calculate a respective score(s) of the similar label(s), and

the prediction means is configured to determine the label to be given to the prediction target object with further reference to the score(s).

According to the above-described configuration, it is possible to determine the label to be given to the prediction target object with consideration given to the score(s) of the similar label(s).

### (Supplementary Note 3)

The information processing apparatus described in supplementary note 1 or 2, wherein

the prediction means is configured to:

predict a yet-to-be-modified label of the prediction target object with use of the prediction model;

predict the similar label(s) with use of the prediction model; and

determine, as the label to be given to the prediction target object, a modified label that is obtained by modifying the yet-to-be-modified label with reference to the similar label(s).

According to the above-described configuration, it is possible to modify, with high accuracy, the yet-to-be-modified label of the prediction target object that has been predicted by the prediction model.

### (Supplementary Note 4)

The information processing apparatus described in supplementary note 3, wherein

the evaluation means identifies a plurality of similar objects, and

the prediction means is configured to:

extract one or more similar labels from a plurality of similar labels given to the plurality of similar objects; and

carry out a comparison between the extracted one or more similar labels and the yet-to-be-modified label to determine the modified label.

According to the above-described configuration, it is possible to, with use of the extracted similar label(s), modify, with higher accuracy, the yet-to-be-modified label of the prediction target object that has been predicted by the prediction model.

### (Supplementary Note 5)

The information processing apparatus described in supplementary note 3 or 4, wherein

the prediction means is configured to:

sort the plurality of similar labels given to the plurality of similar objects with reference to the plurality of similar labels given to the plurality of similar objects and the respective scores of the similar labels;

sort a plurality of yet-to-be-modified labels related to the prediction target object with reference to the plurality of yet-to-be-modified labels related to the prediction target object and the respective scores of the yet-to-be-modified labels; and

determine, as the modified labels, the yet-to-be-modified labels included in M (M is a natural number) top-ranked similar labels given to the plurality of similar objects among N (N is a natural number) top-ranked yet-to-be-modified labels related to the prediction target object.

According to the above-described configuration, it is possible to determine, with high accuracy, a plurality of labels to be given to the prediction target object.

### (Supplementary Note 6)

The information processing apparatus described in supplementary note 5, wherein

the prediction means is configured to:

further sort the plurality of similar labels given to the plurality of similar objects with reference to a hierarchical relationship between the plurality of similar labels; and

determine, as the modified labels, the yet-to-be-modified labels included in M (M is a natural number) top-ranked similar labels given to the plurality of similar objects among N (N is a natural number) top-ranked yet-to-be-modified labels related to the prediction target object.

According to the above-described configuration, it is possible to determine, with higher accuracy, a plurality of labels to be given to the prediction target object with consideration given to the hierarchical relationship.

### (Supplementary Note 7)

The information processing apparatus described in any one of supplementary notes 1 to 6, wherein

the evaluation means is configured to identify the one or more similar objects by outputting a graph representing a similarity relationship between the objects, and

the prediction means is configured to:

extract one or more similar objects that exist within a predetermined number of hops from the prediction target object with reference to the graph; and

determine the label to be given to the prediction target object with reference to the similar label(s) given to the extracted one or more similar objects.

According to the above-described configuration, it is possible to determine, with higher accuracy, the label to be given to the prediction target object with use of the graph representing the similarity relationship between the objects.

### (Supplementary Note 8)

The information processing apparatus described in any one of supplementary notes 1 to 7, wherein

the acquisition means includes:

an acceptance means for accepting a sentence set; and

an entity extraction means for extracting a plurality of entities from the sentence set, and

the acquisition means is configured to acquire, as the set of objects, the plurality of entities that have been extracted by the entity extraction means or a combination of the plurality of entities that have been extracted by the entity extraction means and a sentence from which the plurality of entities are extracted.

According to the above-described configuration, even in a case where only a single prediction model exists, it is possible to, for an entity extracted from a sentence, determine, with high accuracy, the label to be given to the object including the entity.

### (Supplementary Note 9)

The information processing apparatus described in any one of supplementary notes 1 to 8, wherein

the evaluation means includes

an identity evaluation means for evaluating identity between the objects included in the set of objects and identifying, as the similar object, an object which is identical to the prediction target object.

According to the above-described configuration, the evaluation of identity between the objects is carried out, and it is thus possible to determine a label to be given to a prediction target object with higher accuracy.

### (Supplementary Note 10)

The information processing apparatus described in any one of supplementary notes 1 to 9, including

a display means for displaying:

the prediction target object; and

at least one of the similar objects or at least one of the similar labels.

According to the above-described configuration, it is possible for a user of the information processing apparatus to ascertain the prediction target object and the similar object or the similar label.

### (Supplementary Note 11)

The information processing apparatus described in any one of supplementary notes 1 to 9, including

a display means for displaying:

a yet-to-be-modified label of the prediction target object or the label given to the prediction target object; and

the similar label(s).

According to the above-described configuration, it is possible for the user of the information processing apparatus to ascertain the yet-to-be-corrected label of the prediction target object or the label given to the target object and the similar label(s).

### (Supplementary Note 12)

An information processing method comprising:

acquiring a set of objects;

evaluating a degree of similarity between objects included in the set of objects and identifying one or a plurality of similar objects which are similar to a prediction target object; and

determining a label to be given to the prediction target object with reference to a similar label(s), the similar label(s) being a label(s) which is/are given to each of the one or a plurality of similar objects and which has/have been predicted by a prediction model.

The above-described information processing method brings about an effect that is similar to the effect brought about by the information processing apparatus described above.

### (Supplementary Note 13)

An information processing program for causing a computer to carry out:

a process of acquiring a set of objects;

a process of evaluating a degree of similarity between objects included in the set of objects and identifying one or a plurality of similar objects which are similar to a prediction target object; and

a process of determining a label to be given to the prediction target object with reference to a similar label(s), the similar label(s) being a label(s) which is/are given to each of the one or a plurality of similar objects and which has/have been predicted by a prediction model.

The above-described configuration brings about an effect that is similar to the effect brought about by the information processing apparatus described above.

### [Additional Remark 3]

Furthermore, some of or all of the foregoing example embodiments can also be described as below.

An information processing apparatus comprising at least one of processor, the at least one processor being configured to carry out: an acquisition process of acquiring a set of objects; an evaluation process of evaluating a degree of similarity between objects included in the set of objects and identifying one or a plurality of similar objects which are similar to a prediction object; and a prediction process of determining a label to be given to the prediction target object with reference to a similar label(s), the similar label(s) being a label(s) which is/are given to each of the one or a plurality of similar objects and which has/have been predicted by a prediction model.

Note that the information processing apparatus can further include a memory. The memory can store a program for causing the processor to execute the acquisition process, the evaluation process, and the prediction process. The program can be stored in a computer-readable non-transitory tangible storage medium.

### REFERENCE SIGNS LIST

1, 1A, 1B, 1C: information processing apparatus
10A: control unit
11: acquisition unit
12: evaluation unit
13: prediction unit
15C: display unit
20A: storage unit
30A: input/output unit
40A: communication unit
111B: acceptance unit
112B: entity extraction unit
121B: identity evaluation unit

What is claimed is:

1. An information processing apparatus comprising:
at least one processor, the at least one processor being configured to carry out:
an acquisition process of acquiring a set of objects;
an evaluation process of evaluating a degree of similarity between objects included in the set of objects and identifying one or a plurality of similar objects which are similar to a prediction target object; and
a prediction process of for determining a label to be given to the prediction target object with reference to a similar label(s), the similar label(s) being a label(s) which is/are given to each of the one or a plurality of similar objects and which has/have been predicted by a prediction model.

2. The information processing apparatus according to claim 1, wherein
in the evaluation process, the at least one processor is configured to calculate a respective score(s) of the similar label(s), and
in the prediction process, the at least one processor is configured to determine the label to be given to the prediction target object with further reference to the score(s).

3. The information processing apparatus according to claim 1, wherein
in the prediction process, the at least one processor is configured to:
predict a yet-to-be-modified label of the prediction target object with use of the prediction model;
predict the similar label(s) with use of the prediction model; and
determine, as the label to be given to the prediction target object, a modified label that is obtained by modifying the yet-to-be-modified label with reference to the similar label(s).

4. The information processing apparatus according to claim 3, wherein
in the evaluation process, the at least one processor identifies a plurality of similar objects, and
in the prediction process, the at least one processor is configured to:
extract one or more similar labels from a plurality of similar labels given to the plurality of similar objects; and
carry out a comparison between the extracted one or more similar labels and the yet-to-be-modified label to determine the modified label.

5. The information processing apparatus according to claim 3, wherein
in the prediction process, the at least one processor is configured to:
sort the plurality of similar labels given to the plurality of similar objects with reference to the plurality of similar labels given to the plurality of similar objects and the respective scores of the similar labels;
sort a plurality of yet-to-be-modified labels related to the prediction target object with reference to the plurality of yet-to-be-modified labels related to the prediction target object and the respective scores of the yet-to-be-modified labels; and
determine, as the modified labels, the yet-to-be-modified labels included in M (M is a natural number) top-ranked similar labels given to the plurality of similar objects among N (N is a natural number) top-ranked yet-to-be-modified labels related to the prediction target object.

6. The information processing apparatus according to claim 5, wherein
in the prediction process, the at least one processor is configured to:
further sort the plurality of similar labels given to the plurality of similar objects with reference to a hierarchical relationship between the plurality of similar labels; and
determine, as the modified labels, the yet-to-be-modified labels included in M (M is a natural number) top-ranked similar labels given to the plurality of similar objects among N (N is a natural number) top-ranked yet-to-be-modified labels related to the prediction target object.

7. The information processing apparatus according to claim 1, wherein
in the evaluation process, the at least one processor is configured to identify the one or more similar objects by outputting a graph representing a similarity relationship between the objects, and
in the prediction process, the at least one processor is configured to:
extract one or more similar objects that exist within a predetermined number of hops from the prediction target object with reference to the graph; and
determine the label to be given to the prediction target object with reference to the similar label(s) given to the extracted one or more similar objects.

8. The information processing apparatus according to claim 1, wherein
in the acquisition process, the at least one processor is configured to carry out:
an acceptance process of accepting a sentence set; and
an entity extraction process of extracting a plurality of entities from the sentence set, and
the at least one processor is configured to acquire, as the set of objects, the plurality of entities that have been extracted in the entity extraction process or a combination of the plurality of entities that have been extracted in the entity extraction process and a sentence from which the plurality of entities are extracted.

9. The information processing apparatus according to claim 1, wherein
in the evaluation process, the at least one processor is configured to carry out
an identity evaluation process of evaluating identity between the objects included in the set of objects and identifying, as the similar object, an object which is identical to the prediction target object.

10. The information processing apparatus according to claim 1, wherein
the at least one processor is configured to carry out a display process of displaying:
the prediction target object; and
at least one of the similar objects or at least one of the similar labels.

11. The information processing apparatus according to claim 1, wherein
the at least one processor is configured to carry out a display process of displaying:
a yet-to-be-modified label of the prediction target object or the label given to the prediction target object; and
the similar label(s).

12. An information processing method comprising:
acquiring a set of objects;
evaluating a degree of similarity between objects included in the set of objects and identifying one or a plurality of similar objects which are similar to a prediction target object; and
determining a label to be given to the prediction target object with reference to a similar label(s), the similar label(s) being a label(s) which is/are given to each of the one or a plurality of similar objects and which has/have been predicted by a prediction model.

13. A computer-readable non-transitory storage medium storing a program for causing a computer to function as an information processing apparatus, the program causing the computer to carry out:
a process of acquiring a set of objects;
a process of evaluating a degree of similarity between objects included in the set of objects and identifying one or a plurality of similar objects which are similar to a prediction target object; and
a process of determining a label to be given to the prediction target object with reference to a similar label(s), the similar label(s) being a label(s) which is/are given to each of the one or a plurality of similar objects and which has/have been predicted by a prediction model.
